(19) United States
(12) Patent Application Publication
(10) Pub. No.: US 2005/0052394 A1
(43) Pub. Date: Mar. 10, 2005

(54) Liquid crystal display driver circuit with optimized frame buffering and method therefore

(76) Inventor: John Karl Waterman, Mesa, AZ (US)

Correspondence Address: INGRASSIA FISHER & LORENZ, P.C., 7150 E. CAMELBACK, STE. 325, SCOTTSDALE, AZ, 85251, US

(21) Appl. No.: 10/644,151

(22) Filed: Aug. 19, 2003

(51) Int. Cl. G09G 3/36

(52) U.S. Cl. 345/98

(57) ABSTRACT

Methods and apparatus are provided for a liquid crystal microdisplay. The apparatus comprises a display driver integrated circuit, a memory, and at least one liquid crystal microdisplay. The memory is coupled to the display driver integrated circuit. The at least one liquid crystal display is also coupled to the display driver integrated circuit. A frame of video information is written to the memory in a same time period as a previously stored frame of video information is read from the memory more than one time. The previously stored frame of video information that is read from memory more than one time is provided to the at least one liquid crystal microdisplay. The method comprises identifying the start of an incoming frame of video information. The incoming frame of video information is written to a memory within a time period having a predetermined duration. A previously stored frame of video information is read from the memory more than one time and provided to the liquid crystal microdisplay.

### FIELD OF THE INVENTION

The present invention generally relates to liquid crystal display systems, and more particularly relates to system architecture for driving a liquid crystal microdisplay.

### BACKGROUND OF THE INVENTION

In recent years there have been many new types of video display technologies being offered commercially such as thin film transistor (TFT), field emission device (FED), plasma, and digital light processing (DLP). One type of display that has is suitable for a wide variety of applications is a liquid crystal display (LCD). Liquid crystal displays are used in commercial products ranging from calculators to high definition televisions and projectors. Liquid crystal displays have many attributes that make them attractive to a product designer. For example, liquid crystal displays are cost effective, low power, light weight, high contrast, and have optimal packaging dimensions.

A liquid crystal display operates by controlling the amount of light passing through the display. One type of liquid crystal display that is suitable for high definition or high-resolution applications is known as a reflective liquid crystal microdisplay. The reflective liquid crystal microdisplay is fabricated using semiconductor manufacturing techniques. In general, a liquid crystal display comprises liquid crystal material between two conductive layers. In the case of a reflective liquid crystal microdisplay, one layer is a transparent conductive layer and the other is a conductive reflective layer. The conductive reflective layer is divided up into an array of reflective pads such that each reflective pad can be provided an independent voltage. The conductive reflective layer typically is made of an aluminum alloy which is a common interconnect material in semiconductor manufacturing.

Each reflective pad corresponds to a pixel or picture element of the LCD microdisplay. A differential voltage is applied across the liquid crystal material to control the molecular alignment. The molecular alignment determines the amount of light that passes through the liquid crystal material and is reflected back to the viewer's eye. The range is controllable from zero to all light reflected back and all gray shades in-between. Thus, an image can be created by individually controlling the amount of light reflected back from each pixel of the array of pixels.

As mentioned previously, a liquid crystal microdisplay is fabricated as part of a semiconductor chip. In general, the liquid crystal microdisplay overlays circuitry for receiving and storing video information for each pixel of the array of pixels. The circuitry is placed on the semiconductor wafer followed by the processing steps to form the liquid crystal microdisplay. The video information is typically provided as a sequence of analog voltages that are coupled to and stored by circuitry for each pixel. The amount of video information required to activate each pixel of the liquid crystal microdisplay is known as a frame of video information. Frames of video information are provided to a liquid crystal microdisplay at a rate of 30-60 times per second.

The growing commercial market for high quality displays along with the ability to manufacture high pixel count liquid crystal microdisplays is pushing the limit of both display technology and the display driver circuitry. In general, a display driver circuit receives video information, processes the video information, and provides it in the proper format for the display it is driving. The video information provided to the display driver circuit is digital. The display driver circuit converts the digital video information to analog and provides it to the liquid crystal microdisplay in a controlled clocked environment.

The number of video formats has grown dramatically in recent years. It is desirable for a display driver circuit to be flexible enough to handle as wide a range of video formats as possible. For example, VGA (Video Graphics Array), SVGA (Super Video Graphics Array), XGA (Extended Graphics Array), and SXGA (Super Extended Graphics Array) are a few of the widely known video standards that a typical display driver circuit must handle. HDTV, WUXGA, QXGA, and QUXGA are examples of newer formats for high-resolution video displays. The format is directly related to the number of rows and columns of pixels in a liquid crystal microdisplay. The new higher resolution video formats place a significant burden on display driver circuits to handle and process large amounts of data in the same amount of time as the older formats.

Accordingly, it is desirable for a display driver circuit to handle a wide variety of high-resolution display formats. In addition, it is desirable to reduce the component count of a liquid crystal display system, increase reliability, and lower cost. Furthermore, other desirable features and characteristics of the present invention will become apparent from the subsequent detailed description and the appended claims, taken in conjunction with the accompanying drawings and the foregoing technical field and background.

### BRIEF SUMMARY OF THE INVENTION

An apparatus is provided for a liquid crystal display system. The apparatus comprises a display driver integrated circuit, a memory, and at least one liquid crystal microdisplay. The memory is coupled to the display driver integrated circuit. The at least one liquid crystal display is also coupled to the display driver integrated circuit. A frame of video information is written to the memory in a same time period as a previously stored frame of video information is read from the memory more than one time. The previously stored frame of video information that is read from memory more than one time is provided to the at least one liquid crystal microdisplay.

A method for providing frames of video information to a liquid crystal microdisplay is described. The method comprises providing frames of video information. The start of an incoming frame of video information is identified. The incoming frame of video information is written to a memory within a time period having a predetermined duration. A previously stored frame of video information is read from the memory more than one time and provided to the liquid crystal microdisplay.

### BRIEF DESCRIPTION OF THE DRAWINGS

The present invention will hereinafter be described in conjunction with the following drawing figures, wherein like numerals denote like elements, and

FIG. 1 is a block diagram of a prior art array of pixels of a liquid crystal microdisplay;

FIG. 2 is a chart listing some of the current and future video formats for displays;

FIG. 3 is a block diagram of a liquid crystal display system in accordance with the present invention;

FIG. 4 is a block diagram of circuitry within a liquid crystal display driver circuit to read and write to a memory in accordance with the present invention;

FIG. 5 is a timing diagram illustrating a memory being controlled by a liquid crystal display driver circuit to provide a higher output frame rate than an input frame rate in accordance with the present invention; and

FIG. 6 is a timing diagram illustrating a memory being controlled by a liquid crystal display driver circuit having a storage capability less than two frames of video information in accordance with the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

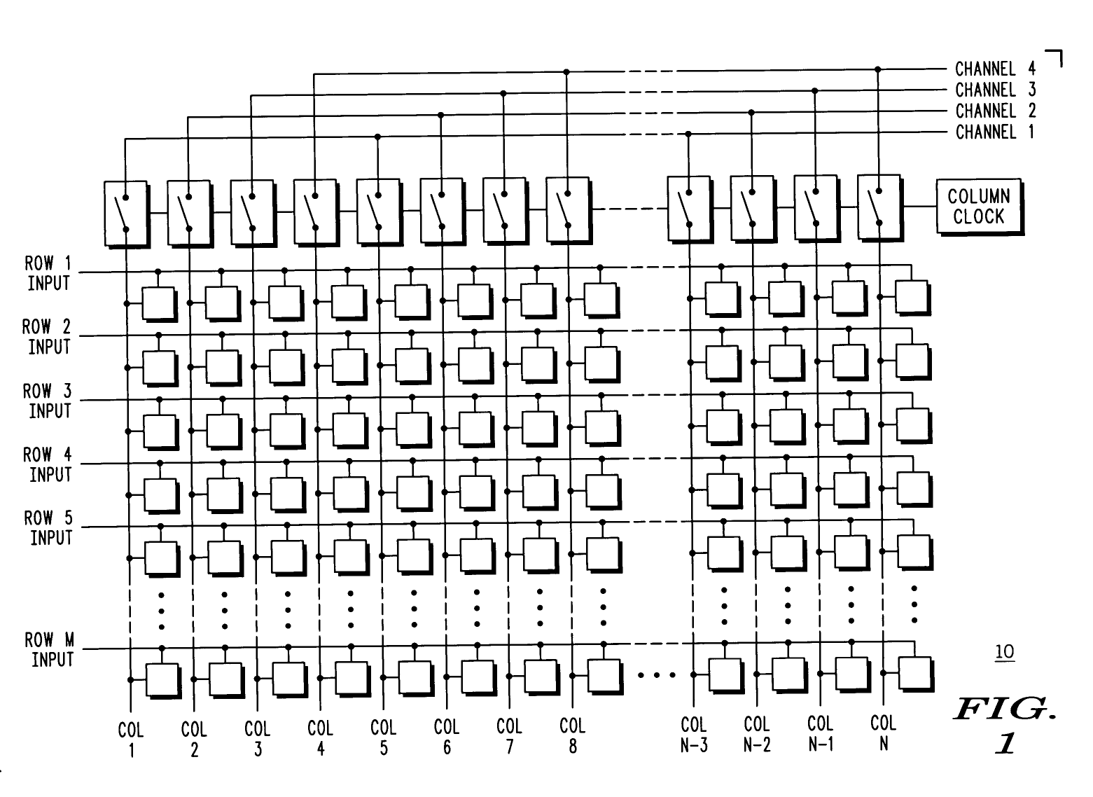

FIG. 1 is a block diagram of a prior art array of pixels 10. Array of pixels 10 is a component of a liquid crystal microdisplay that contains thousands to millions of individually controlled pixel elements. In general, a frame of video information is the amount of digital video information required to individually enable each liquid crystal pixel of array of pixels 10. Typically, a digital word in a stream of video information corresponds to an analog voltage that is applied to a specific pixel in array of pixels 10. A frame of video information forms an image on the liquid crystal microdisplay. Frames of video information are provided to array of pixels 10 at a rate of 60-120 times a second that is not perceptible to the human eye. A viewer will see a contiguous image where motion, for example, movement of an object such as a human being or a car is seen as it would occur naturally even though the image is changed discretely frame by frame.

Array of pixels 10 is arranged in rows and columns. As shown, array of pixels 10 has N columns and M rows. A specific row and column identifies an individual pixel of array of pixels 10. Each of the M rows receives a row enable signal for enabling the row to receive video information. A row 1 enable signal applied to a row 1 input enables the N pixels in row 1 to receive video information. Typically, only one row of the M rows is enabled at a time. The rows are enabled sequentially from row 1 to row M when providing a frame of video information to array of pixels 10. It should be noted that the video information being provided to a display driver circuit includes information indicating the start and end of a frame of video information.

Channels 1-4 are switchably coupled to array of pixels 10. Multiple channels are used to simultaneously couple video information to more than one pixel at a time. For example, columns 1-4 are respectively coupled through switches to channels 1-4. Similarly, the next four columns 5-8 are respectively coupled through switches to channels 1-4. The pattern is repeated sequentially in groups of four columns until all the pixel columns have been coupled to channels 1-4. Channels 1-4 are for illustration purposes only and the actual number of channels used is an engineering decision that is a function of the application and the desired cost to manufacture the display. In general, the amount of video information that can be transferred to a liquid crystal microdisplay in a given time period increases with the number of channels provided.

Channels 1-4 couple video information to array of pixels 10. Video information for a pixel of a liquid crystal microdisplay is an analog voltage. The analog voltage determines the gray shade of the pixel (the amount of light that passes through the liquid crystal material). In a reflective liquid crystal microdisplay, the analog voltage determines the amount of light passed through the pixel and reflected back to the viewer. Although not shown, there is circuitry to store the analog voltage for each pixel of array of pixels 10. Each frame, a storage circuit holds and applies an analog voltage to a corresponding pixel while the frame of video information is provided row by row to array of pixels 10. The storage circuitry holds the stored voltage until it is overwritten with the next frame of video information.

Thus, a sequence for writing a frame of video information to array of pixels 10 begins with row 1 being enabled. A column clock sequentially enables four switches at a time coupling an analog voltage (video information) applied to channels 1-4 pixels of row 1. The column clock sequences the switches coupling row 1 pixels until the final 4 pixels of row 1 corresponding to columns N-3, N-2, N-1, and N are written to. Thus, an analog voltage has been applied and stored for each pixel of row 1. This process of writing to a row through the four channels is repeated until all M rows have been written to. When completed, a frame of video information will have been written to array of pixels 10 and a complete image is provided by the liquid crystal microdisplay. The process does not stop with a single image being provided to the liquid crystal microdisplay. Frames of video information are provided to the array of pixels 10 at a rate of 60-120 frames a second.

To view the image on array of pixels 10 it must be magnified many times its original size using optical means such as lenses. The resolution of the liquid crystal microdisplay is related to the number of pixels in array of pixels 10. For example, an image on array of pixels 10 could be magnified to a point where each pixel is visible or the transition from pixel to pixel from a viewer perspective appears as if the image is made of discrete points. A similar situation occurs in conventional large screen cathode ray tube display systems where the individual lines of video information are visible as the image size is increased. The solution to this problem is to increase the number of pixels on array of pixels 10 to a point where the individual pixel is not discernible to the human eye for the selected magnified image size. Thus, there is a need for ever increasing pixel counts for array of pixels 10 as consumers demand larger and higher quality video displays.

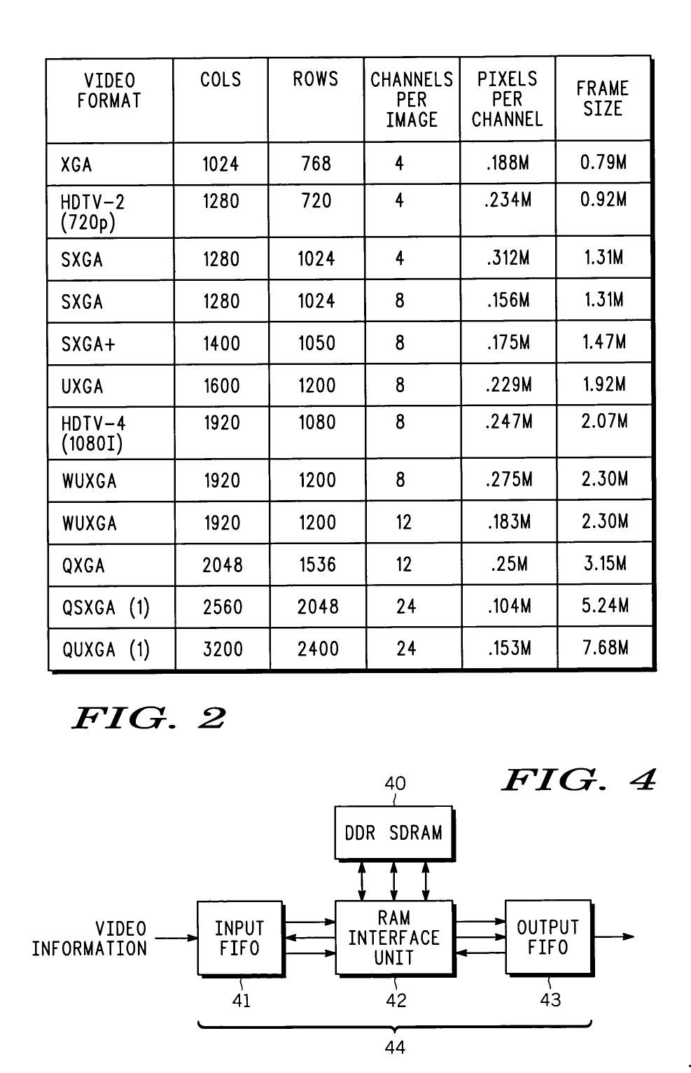

FIG. 2 is a chart listing some of the current and future video formats for displays. The listings are described by the number of columns (Cols) and rows which comprise the video format. XGA and SXGA are commonly offered video formats. The XGA format is for a display having 1024 columns by 768 rows or 786,432 pixels. The rate at which the frame of video information is provided is typically 60 hertz. In other words, video information is provided to each of the 786,432 pixels of a display 60 times a second. Similarly, SXGA has a slightly different aspect ratio having 1280 columns by 1024 rows or 1,310,720 pixels.

Moving farther down the chart there are listed formats such as HDTV-4, WUXGA, and QXGA that are video formats with even larger pixel counts. At the extreme is QUXGA(1), which is a video format for a display having 3200 columns by 2400 rows. This format might be used for a large screen, for example digital projection at a movie theater. A QUXGA(1) liquid crystal microdisplay would has 7,680,000 pixels. Providing this level of video information on a continuous basis to a liquid crystal microdisplay pushes the limits of what can be accomplished with the technology available today.

Information pertaining to an example liquid crystal display system is also provided in the chart of FIG. 2. The liquid crystal display system may use more than one liquid crystal microdisplay depending on the system architecture. In one embodiment, three reflective liquid crystal microdisplays (imagers) are used to create a color image. A light source provides white light that is broken down into red, green, and blue light using prisms. The RGB (red, green, blue) light is respectively focused at a first, second, and third reflective liquid crystal microdisplay. The red, blue, and green light is modified by the image formed on the corresponding reflective liquid crystal microdisplay. The reflected red, blue, and green images from the three reflected liquid crystal microdisplays are combined (through a prism) into a single color image. The size of the single color image is then magnified by the use of optics to form a much larger image.

A liquid crystal display (LCD) driver circuit is an integrated circuit designed to transfer video information to a liquid crystal microdisplay. One of the unique aspects of a liquid crystal microdisplay is that video information cannot be delivered having the same polarity on a continuous basis. Liquid crystal material degrades over time under this condition causing the display to fail. Frame inversion is a technique that is employed to prevent liquid crystal degradation. Frame inversion utilizes the fact that liquid crystal material is sensitive to the magnitude of the differential voltage placed across it but not the polarity of the differential voltage. In frame inversion, two frames of video information are provided to the liquid crystal microdisplay in a time period where a single frame of video information is provided for other display types. The two frames provide identical video content but are provided to the liquid crystal microdisplay having the opposite polarity. In other words, the same differential voltage is provided twice but of opposite polarity. Thus, a LCD display driver circuit receiving frames of video information at 60 hertz will output two frames of video information during the same time period to the liquid crystal microdisplay thereby operating at twice the speed (120 hertz).

Referring to the chart of FIG. 2, the channels per imager column is an example of the number of channels needed to ensure that the video information can be processed and written to a liquid crystal display for the listed video format in the time period provided. The incoming video information is typically provided at 60 frames per minute (60 hertz). It should be noted that the number of channels indicated on the chart are merely examples of the channels that might be used for a given video format. The number of channels listed ranges from 4 channels (per liquid crystal display) for the XGA video format to 24 channels for QUXGA video format. The number of channels goes up correspondingly as the number of pixels in the video format increases. The pixels per channel (in millions) column shows the number of pixels that are written by each channel for a frame of video information in a given video format. The frame size column lists the amount of video information in Megabytes (Byte) to store a frame of video information corresponding to a specific video format. The output frame rate is 120 hertz for every video format. The 120 hertz relates to the fact that both a non-inverted and inverted frame of video information is provided to prevent degradation of the liquid crystal microdisplay.

As shown hereinabove, a LCD display driver circuit operating under the QUXGA(1) video format will receive, process, and provide both a frame and an inverted frame of video information for 7,680,000 pixels in 1/60 of a second. In other words, a frame and inverted frame are provided at a rate of 120 hertz or twice the incoming rate of the video information. It should be noted that the LCD display driver circuit is not merely an interface to a liquid crystal microdisplay but processes the video information as well. For example, the video information is provided in a digital format but is provided to the liquid crystal microdisplay as discrete analog voltages. The LCD display driver circuit includes circuitry to convert digital video information to analog video information. Furthermore, the LCD display driver circuit is capable of performing both digital signal processing and analog signal processing to the video information thereby changing it in a controlled manner. The architecture of the LCD display driver circuit greatly impacts the overall cost of the integrated circuit as well as its ability to efficiently handle and process large quantities of video information at high speeds. Moreover, the higher pixel count video formats are used where resolution and contrast are critical parameters of the application, thus quality of the signal processing cannot be compromised but in fact must be enhanced even though the amount of video information being processed increases significantly.

The amount of information required to be processed for these future video formats pushes the limits of the current state of the art. Providing the video information through multiple channels simultaneously is one method to reduce the amount of time required to provide a frame of video information to a liquid crystal display. In general, the video information is stored in memory. One reason for storing the incoming video information in memory is to allow a frame of data to be provided twice. Storing the incoming frame of video information is also known as frame buffering. As mentioned previously, a frame of video information is output as a non-inverted frame and inverted frame to prevent the liquid crystal display from degrading. The non-inverted frame and inverted frame provide identical video information because a liquid crystal display is insensitive to voltage polarity.

Prior art liquid crystal display driver circuits capable of frame buffering use two separate memories to accomplish the continuous storage and output of the non-inverted and inverted frames of video information. The incoming frame of video information is stored in a first memory while the previously stored frame of video information is output twice from the second memory. Both events, writing in a new frame of video information and outputting the previously stored video information occur during the same period of time. The frame of video information is output at twice the rate at which the incoming frame is stored. In a next frame cycle, the second memory stores the incoming frame of video information while the frame of video information stored in the first memory is read out twice. The cycle repeats with each memory toggling back and forth between writing a frame of video information and reading the stored frame of video information twice, Using two separate memories increases board complexity and size, it also increases the cost to manufacture a liquid crystal display system.

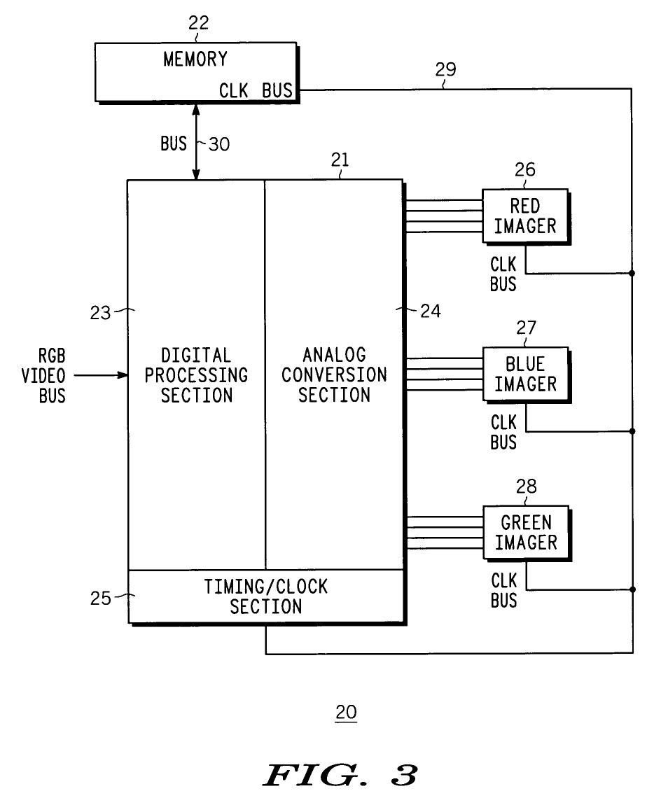

FIG. 3 is a block diagram of a liquid crystal display system 20 in accordance with the present invention. System 20 comprises a display driver integrated circuit 21, a memory 22, a red imager 26, a blue imager 27, and a green imager 28. In an embodiment of liquid crystal display system 20, red imager 26, blue imager 27, and green imager 28 are reflective liquid crystal microdisplays. Display driver integrated circuit 21 includes a digital processing section 23, an analog conversion section 24, and a timing/clock section 25. In general, system 20 receives video information, processes the video information, and outputs the video information in a proper format for each liquid crystal microdisplay. The processing of the video information may include manipulation of the data and error correction as required to enhance the image quality of the display.

In an embodiment of system 20, a RGB (Red, Green, Blue) video bus provides color video information to display driver integrated circuit 21. The color video information is in a digital format. A frame of video information corresponds to an amount of data needed to write to each pixel of a liquid crystal microdisplay. As mentioned previously, a frame of video information is provided at a rate of 30-60 hertz. The human eye cannot perceive these rapid frame by frame changes on the display, thus appearing as a continuous motion similar to what we see in the real world.

Memory 22 is used as a frame buffer to store video information. Storing the incoming video information simplifies the problem of providing the output video information at twice the speed. Memory 22 aids in frame inversion by allowing the stored video information twice at a higher rate of speed than the incoming video information. Thus, the problem of liquid crystal degradation is mitigated by first reading the stored frame of video information from memory 22 and providing the stored information having a first polarity. The stored frame of video information in memory 22 is then read again and provided having an equal voltage magnitude (for each pixel) but opposite voltage polarity. As previously mentioned, a liquid crystal display is sensitive only to voltage magnitude and not voltage polarity. This does not cause a timing problem because the video information is provided at twice the rate of incoming video information.

For example, assume that a frame of video information is provided to display driver integrated circuit 21 every 16.667 milliseconds (60 hertz) from the RGB video bus. Memory 22 in conjunction with display driver integrated circuit 21 provides a frame of video information in the first 8.333 milliseconds (120 hertz) to each liquid crystal microdisplay and then a second frame of video information of the opposite polarity (but equal magnitude) during the next 8.333 milliseconds. The video information is being output at twice the rate (120 hertz) but creates an identical image on the display over the 16.667 millisecond period while ensuring long term reliability by preventing degradation of the liquid crystal display.

It should be noted that memory 22 is a single memory. The exact methodology on how a single memory implementation is achieved will be described in detail hereinbelow. Prior art display driver circuits for driving liquid crystal displays utilize two memories to achieve frame inversion. The reason two memories are used in prior art liquid crystal display driver circuits is directly related to the fact that opposite polarity frames (frame inversion) have to be provided at twice the incoming video information rate to prevent degradation of the liquid crystal microdisplays. As mentioned previously, the operation of a two memory system writes to one memory while reading from the other. For example, a frame of incoming video information is written to a first memory while a previously stored frame of video information is read out from a second memory. The second memory shifts out the previous stored frame of video information twice for providing frames of video information of opposite polarity. The second memory provides the two frames of video information at twice the speed (or faster) as the incoming video information being written to the first memory thereby completing this process in approximately the same time as the write sequence to the first memory. The process is then repeated with the first and second memories swapping roles. An incoming frame of video information is written to the second memory while the frame of video information stored in the first memory is read out twice. This process is repeated with memories toggling back and forth between reading and writing frames (or partial frames) of video information. The use of two memories increases board complexity, part count, and cost.

Digital processing section 23 of display driver integrated circuit 11 is coupled to the RGB video bus. Typically, the RGB video bus includes clock timing. In an embodiment of system 20, digital processing section 23 decouples the external timing from the RGB video bus with the timing internal to display driver integrated circuit 21. This allows the timing of system 20 to be accurately controlled but does not hinder display driver integrated circuit from receiving video information from the RGB video bus. Timing/clock section 25 provides a master clock and other derivative timings to manage the flow of data throughout system 20 and imagers 26, 27, and 28. Another function of digital processing section 23 is to manipulate or modify the digital video information being input. For example, digital processing section 23 provides black synthetic frames when video information is not present or corrupted, provides frame resizing, softens or modifies the image, and aids in optical alignment of the image.

Analog conversion section 24 converts the digital information to a corresponding analog voltage that is then provided to the display. Analog conversion section 24 may include a large number of digital to analog converters depending on the requirements of the display. As shown, display driver integrated circuit 21 has twelve channels of output. Each channel provides an analog voltage to the display corresponding to digital video information provided on the RGB video bus. Similar to digital processing section 23, manipulation of the video information may be desirable in analog conversion section 24. Oft times it is easier to manipulate an analog signal than a digital signal and vice versa. For example, left/right shift, top/bottom shift, and uniformity correction are among the data modifications that can be performed in analog conversion section 24.

As mentioned previously, red imager 26, blue imager 27, and green imager 28 are reflective liquid crystal microdisplays. Liquid crystal technology has proven ideal for a wide variety of applications. Liquid crystal displays are commonly used for portable and low power display applications. Wireless phones, PDAs, watches, and calculators are but a few of the products incorporating liquid crystal displays (LDCs). Liquid crystal technology has proven adaptable to semiconductor wafer processing which has enhanced the capability to the point where it is a viable (and often superior) alternative to other high quality display technologies. This is evidenced by the growing use of LCDs for computer displays and big screen high definition televisions.

A liquid crystal microdisplay is formed on a semiconductor wafer using semiconductor manufacturing techniques to efficiently manufacture thousands to millions of liquid crystal pixels. Furthermore, circuitry for storing and gating the video information is also formed on the semiconductor wafer. The current state of the art has pixel dimensions of approximately 5-20 microns per side (25-400 square micron pixels). In an embodiment of system 20, red imager 26, blue imager 27, and green imager 28 are reflective liquid crystal displays which are often called a LCOS (Liquid Crystal On Semiconductor) display. The pixels of a LCOS display are arranged in rows and columns. Each pixel is a liquid crystal element comprising a substrate, a reflective conductive layer (ex. Aluminum or an Aluminum alloy), a layer of liquid crystal material, a transparent conductive layer (ex. Indium-Tin-Oxide (ITO)), and a transparent protective layer (ex. glass).

The reflective liquid crystal microdisplay operates by controlling the amount of light reflected to the viewer's eye from each pixel of the display. The composite reflected light from all the pixels of the display form an image. In general, light passes through the protective layer, the transparent conductive layer, and the liquid crystal material to the reflective conductive layer where it is reflected back to the viewer. The amount of light that passes through the liquid crystal material and is reflected back to the viewer is a function of the orientation of the liquid crystal molecules. A difference voltage corresponding to the difference in voltage applied to the reflective conductive layer and the transparent conductive layer creates an electric field across the liquid crystal material that aligns the molecules of the liquid crystal material. The liquid crystal material is sensitive only to the magnitude of the differential voltage and not the polarity. Each pixel is individually controllable to allow a range of light to be reflected back to the viewer from white (all light reflected back) to black (no light is reflected back). Variations between white and black are known as grey shades.

System 20 combines reflected images from red imager 26, blue imager 27, and green imager 28 to create a color image (not shown). As their names imply, red, blue, and green light is focused at red imager 26, blue imager 27, and green imager 28. In general, by combining red, green, and blue colored light it is possible to create a wide palette of colors suitable for a high quality display. A display of this type (using three separate liquid crystal microdisplays) is often referred to as a cube system because of the use of prisms which are placed in a cube configuration. A lamp (not shown) provides light that is split into 3 beams by prisms (not shown) and respectively directed at red imager 26, blue imager 27, and green imager 28. A red, green, and blue color filter (not shown) is respectively placed in front of red imager 26, blue imager 27, and green imager 28 to apply the appropriate light to each imager. Red imager 26, blue imager 27, and green imager 28 receive a separate frame of video information from display driver integrated circuit 21. Red, green, and blue light reflected respectively from red imager 16, blue imager 17, and green imager 18 is recombined to form a final color image. Optics (not shown) are used to project the final color image to a display surface.

It should be noted that there are many different methodologies to create a display utilizing a pixel based liquid crystal imager. An alternate method for adding color to a LCOS display utilizes a color wheel and optics. A color wheel is a mechanical rotating device that has red, green, blue, transmissive panels. A light source provides light to the color wheel which is spinning at a predetermine rate. Light passes through the color wheel (red, green, blue, or yellow) to the LCOS imager which is then reflected through optics to form an image on a screen. The speed at which the color wheel spins is synchronized such that color light transmitted through the color wheel is applied to the corresponding color video information applied to the LCOS display (ex. red light/red video information). The advantage of this method is that a single LCOS imager is required. This approach utilizes the fact that the human eye will integrate the three discrete color images into a composite color image. Each color image is being projected at approximately three times the normal frame rate.

Another display methodology utilizes color dots. Similar, to the single imager approach described hereinabove, the use of color dots relies on the visual perception of the human eye. A transmissive color dye (dots) is applied to each pixel of the liquid crystal microdisplay. A color image is created by arranging the colors in the correct order and varying the signal to each pixel based on the color of the pixel. The image created using this technique is perceived as a full color image. This is also somewhat similar to the way a laptop computer screen works. The common thread in different implementations of liquid crystal microdisplays is a pixel based imager that is manufactured using semiconductor wafer processing requiring frame inversion to prevent display degradation. Thus, two memories are being used to store and output video information for the different system architectures to achieve frame inversion.

As shown in FIG. 1, red imager 26, blue imager 27, and green imager 28 are each coupled to display driver integrated circuit 21 through four channels. Each channel provides an analog voltage signal to be applied to a corresponding imager. Having more than one channel decreases the time needed to provide an analog voltage to each pixel of the imager. Thus, display driver integrated circuit 21 is a twelve channel display driver. The twelve channels used in display driver integrated circuit 21 are for illustrative purposes. The number of channels used is a system is a decision based on video information speed and the video formats that are accommodated by the display driver integrated circuit.

FIG. 4 is a block diagram of circuitry within a liquid crystal display driver circuit to read and write to a memory 40 in accordance with the present invention. A block 44 comprises an input first-in, first-out memory (FIFO) 41, a RAM (random access memory) interface unit 42, and an output FIFO 43. In general, memory 40 is a separate integrated circuit from the liquid crystal display driver circuit. At this time, integrating memory 40 with the liquid crystal display driver circuit would not be a cost effective solution due to chip size and wafer processing yields although from a technical perspective it could be achieved. In one embodiment, memory 40 is a double data rate (DDR) synchronous dynamic random access memory (SDRAM). Other similar or equivalent types of memory could also be used.

Input FIFO 41, RAM interface unit 42, and output FIFO 43 combine to allow a single memory to be used that generates a frame rate that is higher at the output of the display driver circuit than the incoming frame rate. In particular, for providing frame inversion to a reflective crystal microdisplay the output frame rate is twice the input frame rate. As mentioned previously, a frame of video information is provided to the liquid crystal display driver circuit at a rate between 30-60 frames per second. Thus, the video information stored in memory 40 is output from block 44 at a rate of 60-120 frames per second.

In general, block 44 operates by repeating a sequence of writing and reading to/from memory 40. The reading sequence is always performed by reading more video information than was written. One reason why more information is read during a read/write sequence is to provide frame inversion to a liquid crystal microdisplay. The amount of video information read is an integer multiple such as 2, 3, or 4 times the amount of video information written. In general, memory 40 has at least enough memory to store 2 frames of video information of the largest video format used by the display driver integrated circuit incorporating block 44. A methodology to provide frame inversion using a single memory having storage capability less than two frames will also be described later hereinbelow.

Input FIFO 41 is sized to store a predetermined amount of video information. In an embodiment of block 44, input FIFO 41 stores an entire video line corresponding to the video format selected for the liquid crystal microdisplay. After the video information is stored in input FIFO 41 it is burst written to memory 40. The path of the video information is from input FIFO 41 to RAM interface unit 42 and from RAM interface unit 42 to memory 40.

RAM interface unit 42 controls the storing and reading of video frames to memory 40 to enable higher frame output rates than input frame rates. RAM interface unit 42 also enables addressing to write in video information for a new frame that does not conflict with the previously written in frame that is being read out at the higher rate of speed. RAM interface unit 42 operates as a slave to both input FIFO 41 and output FIFO 43 servicing requests from both. Another task of the RAM interface unit 42 is to ensure the internal master clock of the liquid crystal display driver circuit and derivative control signals work in synchronization with memory 40. In general, RAM interface unit 42 sequentially addresses data written to and read from memory 40. In other words, RAM interface unit 42 identifies a starting address for both frames of video information that can be stored in memory 40. The addressing is incremented from the starting address such that a frame of video information is sequentially written or read.

The function of output FIFO 43 is to store a predetermined amount of video information such as an entire video line which can then be burst read from memory 40. Output FIFO 43 receives the video information from RAM interface unit 42 and provides the video information to other circuitry within the display driver integrated circuit. As mentioned previously, in a read/write sequence an integer multiple of the data written to memory is provided. For example, a line of video information (corresponding to the number of columns in the selected video format) is stored in input FIFO 41 and RAM interface unit 42 burst reads the line of video information from a new frame to memory 40 in a predetermined memory location. RAM interface unit 42 then addresses a line of video information from the previously stored frame and burst reads it to output FIFO 43. FIFO 42 then provides the line of video information to other circuitry within display driver integrated circuit for further processing. RAM interface unit 42 then addresses a second line of video information from the previously stored frame and burst reads it to output FIFO 43. FIFO 43 then provides the second line of video information to other circuitry within the display driver integrated circuit. The process is repeated with a new write/read/read sequence. Thus, video information is output at twice the rate as it is brought in allowing two frames of the previously stored frame to be output in a same time period as the incoming frame of video information is written to memory 40.

In an embodiment of block 44, an error detection scheme is employed. A cyclic redundancy code is appended to a video line that is written into memory 40. In general, the cyclic redundancy code is generated in input FIFO 41 and checked in output FIFO 43 with RAM interface unit 42 treating the appended code the same as video information. The cyclic redundancy code is checked every time a video line is from memory 40. The cyclic redundancy code provides information on the integrity of the interface to memory 40.

Referring to FIG. 3, display driver integrated circuit 21 includes 12 total channels driving red imager 26, blue imager 27, and green imager 28. In an embodiment of block 44 for liquid crystal display driver integrated circuit 21, input FIFO 41 is organized in three equally sized fifos. The three equally sized fifos respectively store a line of video information for red imager 26, blue imager 27, and green imager 28 thereby simplifying the organization of the incoming video stream. In an embodiment of liquid crystal display driver integrated circuit 21, input FIFO 41 has a 50% storage overhead (more memory than required to store a video line of the largest supported video format). This ensures that input FIFO 41 does not overflow. Using a video line length longer than that supported by input FIFO 41 results in undefined behavior. In an embodiment of display driver integrated circuit 21, storage in input FIFO 41 is in 32 bit word format. A byte of video information is eight bits. Thus, four bytes of video information is stored for each 32 bit word. Input FIFO 41 comprising three equally sized fifos allows three 32 bit words to be output corresponding to 12 bytes of video information. This relates to display driver integrated circuit 21 having 12 channel outputs with four channels each coupling to red imager 26, blue imager 27, and green imager 28.

In an embodiment of display driver integrated circuit 21, output FIFO 43 also has a 50% storage overhead. The added storage capability allows up to fifty percent of a video line extra to be brought in to allow for latency in RAM interface unit 42 servicing output FIFO 43. Exceeding the maximum supported video line length will result in undefined behavior. In one embodiment, output FIFO 43 comprises three equal sized fifos. Similar to input FIFO 41, data is stored in the 32 bit word format. The three equal sized fifos of output FIFO 43 respectively store a video line of information for red imager 26, blue imager 27, and green imager 28. Output FIFO 43 includes control logic that determines how the video information is written from RAM interface unit 42 to output FIFO 43. Each 32 bit word stored in output FIFO 43 corresponds to four bytes of video information. Thus, the three fifos of output FIFO 43 output 12 bytes of video information corresponding to the 12 channels of display driver integrated circuit 21. Furthermore, output FIFO 43 requests a new line of video information from RAM interface unit 43 whenever its internal counter has reached a threshold value programmed into a threshold register. Finally, output FIFO 43 checks the cyclic redundancy code appended to each line of video information and maintains an error count.

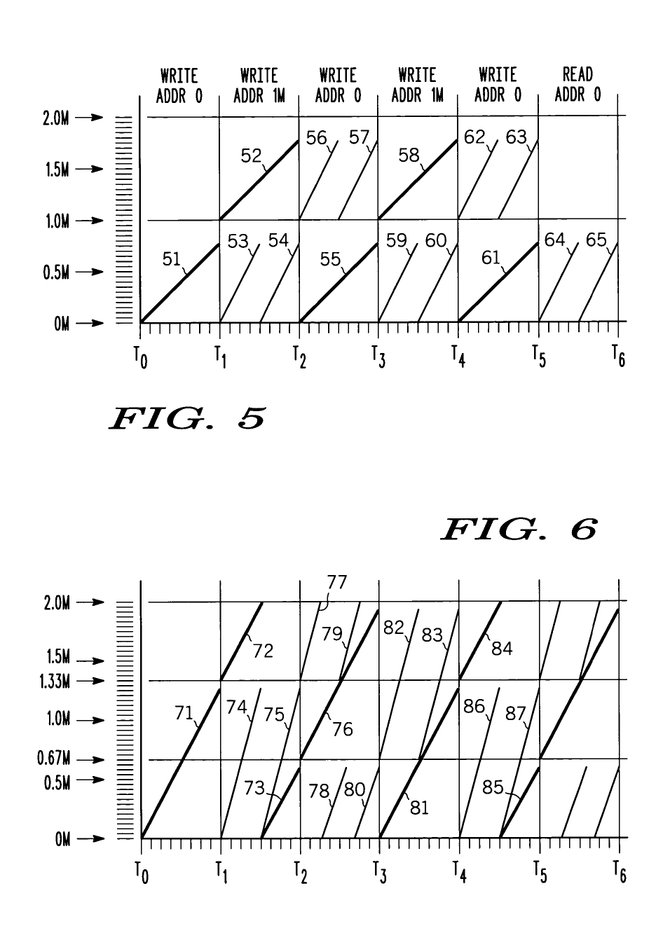

FIG. 5 is a timing diagram illustrating a single memory being operated to provide a higher output frame rate than input frame rate in accordance with the present invention. In the timing diagram a 64 Mbit SDRAM having a 32 bit word length is used as an example of the read/write process. The 64 Mbit SDRAM has two million (2M) addresses with a 32 bit word length and these addresses are shown in the Y-axis of the timing diagram. The use of the 64 Mbit SDRAM is for illustration purposes and the selected size of the memory is based on having enough memory to store approximately 2 frames of video information. The X-axis is time, having an initial time T₀ with a new sequence starting periodically at times T₁ T₂ T₃ T₄ and T₅.

In a time period starting at time T₀, video information is written into memory. The video information being written to the memory is indicated by line 51 starting at address 0 and sequentially incrementing until an entire frame of video information is written to memory. In this embodiment, the number of addresses required to write the frame of video information is less than 1M (million). As shown, less than half the memory is utilized in storing the first frame of video information. Referring to FIG. 4, a line of incoming video information to the liquid crystal display driver integrated circuit is written into input FIFO 41. The line of video information is burst written from input FIFO 41 to memory 40. Line by line the incoming video information is written into input FIFO 41 and burst read into memory 40 until the first frame of video information is stored in memory 40. The amount of time required to write the frame of video information is completed by a time T₁.

In a time period from time T₁ to T₂, both reading and writing is performed on the memory. In an embodiment of the write/read sequence, two lines of video information are read for every line of video information written. A second frame of video information is written to memory starting at address 1M and above and is indicated by line 52. The second frame of video information is written without overwriting on the first frame of video information which is stored in addresses less than 1M. In this embodiment, the first frame of video information is read twice from memory. This is represented by lines 53 and 54 transitioning from address 0 to the maximum address of line 51. Reading the first frame of video information occurs at twice the rate of writing video information. In general, the writes and reads are performed starting at address 1M or address 0 with the addressing sequentially incrementing until the writing or reading of the frame is completed.

It should be noted that reading and writing to the memory does not occur simultaneously. Referring to FIG. 4, a write/read/read sequence (or equivalent) is repeated during each time period. For example, a write/read/read sequence comprises a first line of the second frame of video information being read into input FIFO 41 and then burst read into memory 40. The first line of the first frame of video information is then burst read out of memory 40 into output FIFO 43. The line of video information is then output by output FIFO 43 to other circuitry within the display driver integrated circuit. This is followed by the second line of the first frame of video information burst read into output FIFO 43 and provided within the display driver integrated circuit. The pattern of write/read/read continues until time T₂ when the second frame is written into memory 40 and the first frame of video information has been read out twice such that frame inversion can be implemented to prevent degradation of the liquid crystal microdisplays. So a magnified view of FIG. 5 would show item 52 with a write burst for one line of the second frame, then no activity while item 53 shows a read burst for one line of the first frame followed by a read burst for the next line of the first frame.

In time period T₂-T₃ a third frame of video information is written into the memory. The third frame is written over the first frame of video information that is no longer needed having been read out twice and provided to other circuitry within the display driver integrated circuit during time period T₁-T₂. The third frame of video information being written is indicated by line 55 starting at address 0. Lines 56 and 57 indicate the second frame of video information stored at address 1M and above being read out twice during this time period. As described hereinabove, a write/read/read pattern is deployed repeatably writing a line of video information for the third frame and then reading two lines of the second frame until time T₃ when the third frame has been written to memory and the second frame has been read out twice.

Each time period, a new frame is written into the address locations of the previously read out frame thus toggling back and forth between address 0 and address 1M. The previously written in frame of video information is also read out twice during each time period. In time period T₃-T₄, a fourth frame as indicated by line 58 is written to address 1M and above. The third frame is read out twice as indicated by lines 59 and 60. In time period T₄-T₅, a fifth frame as indicated by line 61 is written to address 0 and above. The fourth frame is read out twice as indicated by lines 62 and 63. Finally, in time period T₅-T₆, the fifth frame is read out twice as indicated lines 64 and 65 with no new frame being written into memory. Only five frames of video information are shown being written into and read out (twice per period) for illustrative purposes in FIG. 5. The process of writing and reading can continue for as long as required. Also, reading a frame of video information twice from memory is for illustrative purposes with the frame being read out more than twice if required.

FIG. 6 is a timing diagram illustrating a memory being controlled by a liquid crystal display driver circuit having a storage capability less than two frames of video information in accordance with the present invention. The timing diagram is broken into 6 time periods (T₀-T₁, T₁-T₂, T₂-T₃, T₃-T₄, T₄-T₅, and T₅-T₆). In general, a frame of video information is written to the memory and the previously stored frame of video information is read out two times (or more) during each period. In the example of FIG. 6, a previously stored frame of video information is written out twice during a time period. The exception occurs in the first time period where a previous stored frame does not exist yet and in the last time period when a new frame of video information is not provided to be written to memory. The addressing of the frame being written to memory is such that it does not overwrite the area of the memory of the previously stored frame that is being read out until it has been read out a final time and is no longer needed. In the limit, this can occur with a line of video information being read (for a final time) and then overwritten immediately with a line from the new frame of video information. The read/write addressing will not track after this point in time because a read occurs at twice (or more) of the rate at which the writing is done.

In the example, the memory is a 64 Mb DDR SDRAM. The 64 Mb memory has a 32 bit word thus having 2M (million) addresses as indicated in the Y-axis of the timing diagram. The memory size selected in this example is for illustrative purposes to show how the scheme is implemented. The size and memory type can be selected based on the requirements of the application. The addressing of the memory is divided up into three equal sections, addresses 0-0.67M, addresses 0.67M-1.33M, and addresses 1.33M-2M. A frame of memory in this example uses less than 1.33M addresses or a combination of less than two of the address sections. In this “rolling address” example, clear timing allows frame rate doubling even though the memory cannot hold 2 full frames. The X-axis is time.

In a first time period T₀-T₁, a first frame of video information is written to memory starting at address 0. The first frame being written is indicated by line 71 and finishes with the last line of video information having an address less than 1.33M.

In a second time period T₁-T₂, a second frame of video information is written to memory and the first frame of video information is read out twice. In an embodiment of the process, a write/read/read sequence is implemented similar to that discussed in FIG. 5. Video information is written and read a line of video information at a time. This accommodates the architecture as disclosed in FIG. 4 for writing and reading to a memory. Thus, a sequence comprises a line of video information of the second frame being written into memory, next a line of video information of the first frame is read, followed by another line of video information of the first frame being read with the sequence repeating itself during the time period until the second frame has been written into memory and the first frame read out of memory twice.

The second frame of video information is written into memory starting at address 1.33M and is indicated by line 72. The first frame of stored video information is being read out of memory at twice the rate as the second frame is being written in. Thus, the first (as indicated by line 74) of the two first frames being read out during T₁-T₂ is read by the time the write addressing reaches the last address 2M (because the amount of video information stored in addresses 1.33M-2M is greater than half the frame size). In other words, the second (as indicated by line 75) of the two first frames being read out during T₁-T₂ has already started to be read out by the time address 2M has been written to. The next incremental write to the memory changes from address 2M to address 0. The second frame of video information written to memory continues writing at address 0 and above as indicated by line 73. Writing a line of video information of the second frame to address 0 overwrites the first frame of video information but does not cause a problem because the first frame of video information at address 0 has already been read out for a second and final time. The write/read/read sequence continues until the second frame has been completely written into memory and the first frame has been read out twice.

In a third time period T₂-T₃, a third frame of video information is written to memory and the second frame of video information is read out twice. The third frame of video information is written into memory starting at address 0.67M and is indicated by line 76. The third frame of video information is stored in addresses ranging from addresses 0.67M and above but less than address 2M. As mentioned previously, the stored video information (second frame) is being read out of memory at twice the rate as the frame of video information (third frame) being written in. The first of the two second frames of video information read out is indicated by lines 77 and 78. Line 77 begins at address 1.33M and ends at address 2M. Line 78 is contiguous (from a read perspective) with line 77 and begins at address 0 and above. The second of the two second frames of vide information read out similarly to lines 77 and 78 and are indicated by lines 79 and 80.

The first of the two second frames has been read out (line 78) before the third frame of video information being written in reaches address 1.33M (line. 76). The second frame of video information has already begun to be read out (line 79) for a final time before line 76 begins overwriting the third frame into address 1.33M and above. The write/read/read sequence continues until the third frame of video information has been written in and the second frame of video information has been read out twice.

In time period T₃-T₄, a fourth frame is written into the memory beginning at address 0 and finishing at an address less than 1.33M as indicated by line 81. The third frame of stored video information is read out of memory twice. The third frame of stored video information starts at address 0.67M and finishes before address 2M as indicated by lines 82 and 83.

In time period T₄-T₅, a fifth frame is written into the memory beginning at address 1.33M to address 2M as indicated by line 84 then transitioning to address 0 as indicated by line 85. The fourth frame of stored video information is read out twice during the time period starts at address 0 and finishes before address 1.33M as indicated by lines 86 and 87. The locations in memory where video information is read and written to in time period T₄-T₅ are identical to time period T₁-T₂. The addressing of where the incoming frames of video information are stored repeats itself beginning in time period T₄-T₅ in a cycle of three time periods corresponding to that shown in time periods T₁-T₂, T₂-T₃, and T₃-T₄. The address for the read and writes for time period T₅-T₆ corresponds to the time period T₂-T₃. Thus, a single memory coupled to a liquid crystal display driver integrated circuit can be implemented to provide a higher output frame rate having an integer multiple (2 or more) of the input frame rate even if the memory is capable of storing less than two frames of video information.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A liquid crystal display system comprising:
a display driver integrated circuit;
a memory coupled to said display driver integrated circuit; and
at least one liquid crystal microdisplay coupled to said display driver integrated circuit wherein a frame of video information is written to said memory in a same time period as a previously stored frame of video information is read from said memory more than one time and provided to said at least one liquid crystal microdisplay.

2. The liquid crystal display system as recited in claim 1 wherein said previously stored frame of video information is read from said memory two times to provide a non-inverted and inverted frame of video information to prevent degradation of said at least one liquid crystal microdisplay.

3. The liquid crystal display system as recited in claim 1 wherein said display driver integrated circuit includes:
an input FIFO;
a RAM interface unit coupled to said input FIFO and said memory; and
an output FIFO coupled to said RAM interface unit and said at least one liquid crystal microdisplay.

4. The liquid crystal display system as recited in claim 3 wherein said input FIFO is capable of storing a line of video information corresponding to a largest video format supported by said display driver integrated circuit.

5. The liquid crystal display system as recited in claim 4 wherein said input FIFO is capable of storing 1.5 lines of video information corresponding to said largest video format support by said display driver integrated circuit to ensure that an overflow condition does not occur.

6. The liquid crystal display system as recited in claim 3 wherein said output FIFO is capable of storing a line of video information corresponding to a largest video format supported by said display driver integrated circuit.

7. The liquid crystal display system as recited in claim 6 wherein said output FIFO is capable of storing 1.5 lines of video information corresponding to said largest video format support by said display driver integrated circuit to allow for latency in said RAM interface unit in servicing said output FIFO.

8. The liquid crystal display system as recited in claim 1 wherein said RAM interface unit controls said input FIFO, said memory, and said output FIFO such that said output FIFO has an output frame rate greater than an input frame rate to said input FIFO.

9. The liquid crystal display system as recited in claim 1 wherein said at least one liquid crystal microdisplay comprises:
a first reflective crystal microdisplay coupled to said display driver integrated circuit;
a second reflective crystal microdisplay coupled to said display driver integrated circuit; and
a third reflective crystal microdisplay coupled to said display driver integrated circuit.

10. A method of providing frames of video information to a liquid crystal display comprising the steps of:
providing frames of video information;
identifying a start of an incoming frame of video information;
writing said incoming frame of video information to a memory within a time period having a predetermined duration;
reading a previously stored frame of video information more than one time from said memory during said time period; and
providing said previously stored frame of video information more than one time to the liquid crystal microdisplay.

11. The method as recited in claim 10 further including a step of repeating the following steps for each provided frame of video information:
identifying a start of an incoming frame of video information;
writing said incoming frame of video information to said memory within a time period having said predetermined duration;
reading a previously stored frame of video information more than one time from said memory during said time period; and
providing said previously stored frame of video information more than one time to the liquid crystal microdisplay.

12. The method as recited in claim 10 wherein said steps of writing said incoming frame of video information to a memory within a time period having a predetermined duration and reading a previously stored frame of video information more than one time from said memory during said time period include the steps of:
writing a line of said incoming frame of video information to said memory;
reading more than one line of said previously stored frame of video information from said memory; and
repeating said steps of writing a line and reading more than one line until said incoming frame is written to said memory and said previously stored frame of video information has been read out more than one time.

13. The method as recited in claim 12 wherein said step of writing a line of aid incoming frame of video information to said memory further includes the steps of:
storing said line of said incoming frame of video information in a fifo; and
writing said line stored in said fifo to said memory.

14. The method as recited in claim 12 wherein said step of reading more than one line of said previously stored frame of video information from said memory further includes the steps of:
reading a line from said previously stored frame of video information in said memory;
storing said line in a fifo;
providing said line in said fifo to the liquid crystal microdisplay;
reading at least one more line from said previously stored frame of video information;
storing said at least one more line from said previously stored frame of video information to said fifo; and
providing said at least one more line in said fifo to the liquid crystal micro display.

15. The method as recited in claim 10 further including the steps of:
partitioning said memory into a first area and a second area;
storing said previously stored frame of video information in said first area of said memory; and
storing said incoming frame of video information in said second area of said memory wherein subsequent incoming frames of video information toggle back and forth being written into said first and second areas of said memory.

16. The method as recited in claim 10 further including a step of overwriting said previously stored frame of video information with video information of said incoming frame after said previously stored frame of video information has been read for a final time such that the memory requires less than two frames of storage capability.

17. A frame buffering section of a liquid crystal microdisplay driver integrated circuit for interfacing with a memory comprising:
an input fifo coupled for receiving incoming video information;
an output fifo for providing video information to other circuitry of the liquid crystal microdisplay driver integrated circuit; and
a RAM interface unit coupled to said input fifo, said output fifo, and the memory wherein said RAM interface unit manages writing stored video information in said input fifo corresponding to an incoming frame of video information to the memory and manages reading stored video information from the memory corresponding to a previously stored frame of video information to said output fifo such that a rate at which video information outputs the output fifo is greater than a rate at which video information is input to the input fifo.

18. The frame buffering section of a liquid crystal microdisplay driver integrated circuit for interfacing with a memory as recited in claim 17 wherein the memory is capable of storing two frames of video information.

19. The frame buffering section of a liquid crystal microdisplay driver integrated circuit for interfacing with a memory as recited in claim 17 wherein the input fifo is capable of storing at least one line of video information.

20. The frame buffering section of a liquid crystal microdisplay driver integrated circuit for interfacing with a memory as recited in claim 17 wherein the output fifo is capable of storing at least one line of video information.

21. A method of handling video information for a liquid crystal microdisplay comprising the steps of:
storing video information from an incoming frame into an input fifo;
writing video information stored in said input fifo to a memory;
reading video information from a previously stored frame of video information in said memory to an output fifo;
providing said video information in said output fifo to said liquid crystal microdisplay; and
repeating said steps listed hereinabove such that said incoming frame is written to said memory and said previously stored frame of video information is read out at least once from said memory in a same time period.

22. The method of handling video information for a liquid crystal microdisplay as recited in claim 21 wherein said step of storing video information from an incoming frame into an input fifo further includes a step of storing one line or less of video information into said input fifo.

23. The method of handling video information for a liquid crystal microdisplay as recited in claim 21 wherein said step of storing video information from an incoming frame into an input fifo further includes a step of storing more than one line of video information into said input fifo.
